(19) United States
(12) Patent Application Publication
(10) Pub. No.: US 2026/0111851 A1
(43) Pub. Date: Apr. 23, 2026

(54) SYSTEM AND METHODS FOR ARTIFICIAL INTELLIGENCE DIAGNOSTICS FOR MARINE EQUIPMENT

(71) Applicant: Durban Equity Holding II, LLC dba YachtWave, Sarasota, FL (US)

(72) Inventor: John Eugene OKeefe, Bradenton, FL (US)

(73) Assignee: Durban Equity Holding II, LLC dba YachtWave, Sarasota, FL (US)

(21) Appl. No.: 18/948,816

(22) Filed: Nov. 15, 2024

Related U.S. Application Data
(60) Provisional application No. 63/709,113, filed on Oct. 18, 2024.

(51) Int. Cl. G06Q 10/20

(52) U.S. Cl. CPC G06Q 10/20

(57) ABSTRACT

The method includes receiving input describing marine equipment and at least one issue associated with the marine equipment. The method includes determining an identification of the marine equipment. Additionally, the method includes applying the input and the identification of the marine equipment to one or more machine learning algorithms. The one or more machine learning algorithms implement one or more rules that classify and identify problems in the marine equipment. The one or more machine learning algorithms are trained based on metadata for the marine equipment and components of the marine equipment. The method includes outputting at least one solution to the at least one issue.

### CROSS-REFERENCE TO RELATED APPLICATIONS

This application claims the benefit of priority of U.S. provisional application number 63/709,113, filed October 18, 2024, title “SYSTEM AND METHODS FOR ARTIFICIAL INTELLIGENCE DIAGNOSTICS FOR MARINE EQUIPMENT,” the entire contents of which are herein incorporated by reference.

### FIELD

The present disclosure relates to equipment diagnostics.

### BACKGROUND

Traditional methods for diagnosing and resolving mechanical issues in marine equipment require specialized knowledge and expertise often not readily available to boat owners or operators. Current diagnostic methods are often time-consuming, costly, and dependent on access to skilled marine mechanics.

As can be seen, there is a need for systems and methods that address the above drawbacks.

### SUMMARY

In one aspect of the present disclosure, a method for artificial intelligence-assisted diagnostic includes receiving input describing marine equipment and at least one issue associated with the marine equipment. The method includes determining an identification of the marine equipment. Additionally, the method includes applying the input and the identification of the marine equipment to one or more machine learning algorithms. The one or more machine learning algorithms implement one or more rules that classify and identify problems in the marine equipment. The one or more machine learning algorithms are trained based on metadata for the marine equipment and components of the marine equipment. The method includes outputting at least one solution to the at least one issue.

In another aspect of the present disclosure, a computer-readable medium stores instructions for causing a processing device to perform a method. The method includes receiving input describing marine equipment and at least one issue associated with the marine equipment. The method includes determining an identification of the marine equipment. Additionally, the method includes applying the input and the identification of the marine equipment to one or more machine learning algorithms. The one or more machine learning algorithms implement one or more rules that classify and identify problems in the marine equipment. The one or more machine learning algorithms are trained based on metadata for the marine equipment and components of the marine equipment. The method includes outputting at least one solution to the at least one issue.

In another aspect of the present disclosure, a system includes a memory devices storing instructions and a processing device. The one or more processors are configured to execute the instructions to perform a method. The method includes receiving input describing marine equipment and at least one issue associated with the marine equipment. The method includes determining an identification of the marine equipment. Additionally, the method includes applying the input and the identification of the marine equipment to one or more machine learning algorithms. The one or more machine learning algorithms implement one or more rules that classify and identify problems in the marine equipment. The one or more machine learning algorithms are trained based on metadata for the marine equipment and components of the marine equipment. The method includes outputting at least one solution to the at least one issue.

### BRIEF DESCRIPTION OF THE DRAWINGS

FIG. 1 is a block diagram of an artificial intelligence (AI) marine diagnostic system, according to aspects of the present disclosure; and

FIG. 2 is flow diagram of a process of using the AI marine diagnostic System of FIG. 1, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, diagnosing and resolving mechanical issues in marine equipment requires a specialized mechanic to diagnose the problem. The existing devices and systems in the field rely on generalized diagnostic tools and lack a proprietary database containing detailed information about specific engines and equipment. This absence of specialized data results in less precise diagnostics and solutions, making it challenging to effectively address the unique needs of marine systems. This often results in generic solutions that fail to address the specific nuances of different engines and equipment. This lack of tailored information leads to less effective troubleshooting and increased downtime, requiring more frequent intervention by skilled mechanics.

Broadly, an embodiment of the present disclosure provides an artificial intelligence (AI) marine diagnostic system that solves the problem of diagnosing and resolving mechanical issues in marine equipment. The AI marine diagnostic system is trained with proprietary rules and specialized marine data. This approach allows the AI to provide accurate, real-time diagnostics and effective solutions for various equipment problems, reducing the need for immediate access to skilled mechanics. By simulating the knowledge of a marine mechanic and offering contact information for further human assistance when necessary, the invention ensures reliable maintenance and repair support, minimizing downtime and operational disruptions for boat owners and operators.

The AI marine diagnostic system provides immediate and accurate diagnostics. The AI marine diagnostic system reduces the reliance on manual inspection, minimizes downtime, and enhances the ability to maintain and repair marine equipment efficiently, even in remote locations, by supplementing automated diagnostics with expert contact information when needed.

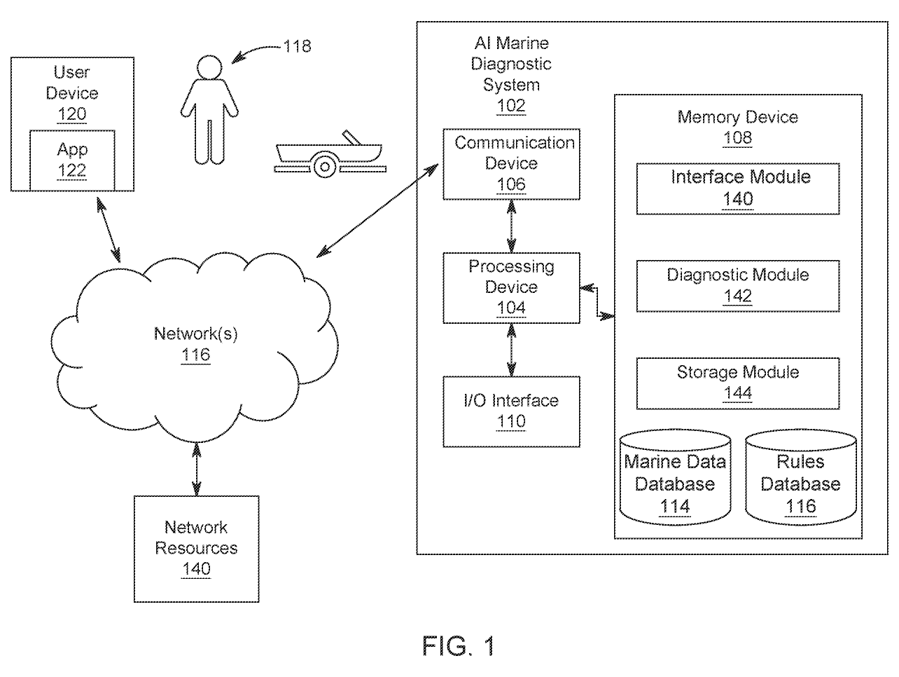

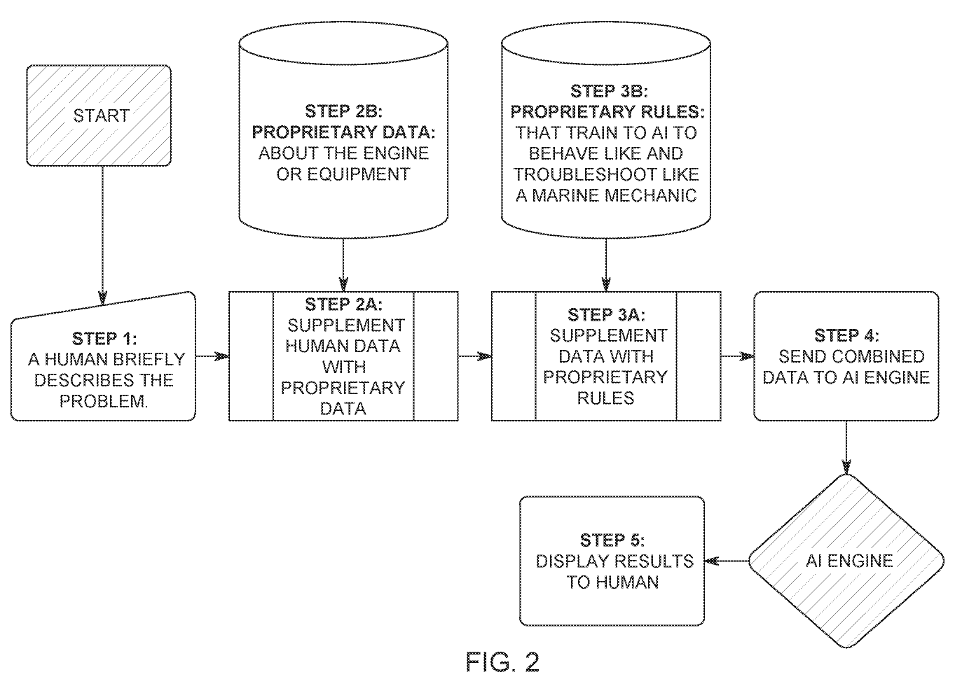

Referring now to FIGS. 1 and 2, FIG. 1 illustrates an AI marine diagnostic system 102, according to aspects of the present disclosure. While FIG. 1 illustrates examples of components of the AI marine diagnostic system 102, additional components can be added and existing components can be removed and/or modified.

The AI marine diagnostic system 102 is configured to diagnose and resolve mechanical issues in marine equipment, for example, marine equipment of a user 118. The AI marine diagnostic system 102 uses one or more machine learning models trained with proprietary rules and specialized marine data. The one or more machine learning models provide accurate, real-time diagnostics and effective solutions for various equipment problems. The AI marine diagnostic system 102 populates and utilizes a proprietary database of detailed engine and equipment information with AI, allowing for highly accurate, tailored diagnostics and solutions. The AI marine diagnostic system 102 reduces downtime, enhances maintenance efficiency, and provides more reliable support for marine equipment by offering precise and context-specific troubleshooting guidance.

As illustrated in FIG. 1, the AI marine diagnostic system 102 includes a processing device 104 coupled to a communication device 106. The processing device 104 is also coupled to a memory device 108, and an input/output (“I/O”) interface 110. In embodiments, the communication interface 106 enables the AI marine diagnostic system 102 to communicate with other devices and systems via one or more networks 116. The AI marine diagnostic system 102 can communicate with the user 118, operating a user device 120, via the network 116. The user device 120 can include one or more electronic devices such as a laptop computer, a desktop computer, a tablet computer, a smartphone, a thin client, and the like.

According to the aspects of the present disclosure, the user device 120 can store and execute a copy of an application 122. The application 122 enables the user 118, operating the user device 120, to communicate with the AI marine diagnostic system 102 and request a diagnosis of one or more problems with marine equipment. In some embodiments, the application 122 can be a specifically designed application that operates with the AI marine diagnostic system 102 to perform the processes and methods described herein. In some embodiments, the AI marine diagnostic system 102 can be a third-party application, such as a web browser, that communicates with the AI marine diagnostic system 102 to perform the processes and methods described herein.

To perform the process described herein, the AI marine diagnostic system 102 can store and execute an interface module 140, a diagnostic module 142, and a storage module 144 to perform the processes and methods described herein. The interface module 140, the diagnostic module 142, and the storage module 144 can be stored in the memory device 108. The interface module 140, the diagnostic module 142, and the storage module 144 can include the necessary logic, instructions, and/or programming to perform the processes and methods described herein. The interface module 140, the diagnostic module 142, and the storage module 144 can be written in any programming language.

The memory device 108 can also include a marine data database 114 and a rules database 116 that stores information and data associated with the process and methods described herein. The marine data database 114 can store detailed information about marine equipment, such as specifications, images of marine craft and parts, and maintenance history. The rules database 116 can store rules that guide diagnostic module 142 to emulate the decision-making of a skilled marine mechanic. The marine data database 114 and the rules database 116 can be any type of database, for example, a hierarchical database, a network database, an object-oriented database, a relational database, a non-relational database, an operational database, and the like.

The interface module 140 operates to generate and provide graphical user interfaces (GUIs) to the application 122, for example, menus, widgets, text, images, fields, etc. Additionally, the interface module 140 can provide data to the application 122, and the application 122 can generate GUIs. The GUIs generated by the interface module 140 and/or the application 122 can be interactive. For example, the GUIs can allow the user 118 of the user devices 120 to capture input about equipment issues is required to make the system interactive and relevant.

The diagnostic module 142 operates to process large datasets, perform natural language processing, and integrate with external databases, which is essential for processing input and generating diagnostics. The diagnostic module 142 can implement one or more machine learning models that are trained using historical data and proprietary rules for accurate diagnostic. The diagnostic module 142 can implement a feedback loop to capture user input on AI responses can help improve the system continuously. The user input can include voice input describing the marine equipment and problems, text input describing the marine equipment and problems, images and videos captured of the marine equipment and problems, etc.

The diagnostic module 142 utilizes proprietary and novel rules to make the AI behave and respond like a marine mechanic by incorporating a combination of domain-specific knowledge, context-aware logic, and personalized interaction patterns. These rules are designed to emulate both the technical expertise and practical problem-solving approach that marine mechanics use in real-world scenarios, ensuring the AI not only delivers accurate information but also presents it in a manner that aligns with the communication style and troubleshooting process of a professional marine engine mechanic.

The AI’s rules are not static but continuously evolve based on user feedback, real-world mechanic experiences, and new marine engine technologies. Proprietary rules allow the AI to adapt its responses as new data and insights become available. In general, the rules include the following:

Domain-Specific Technical Expertise Rules—The core of making the AI behave like a marine mechanic is embedding detailed knowledge of best practices for marine equipment and engine maintenance and repair. The proprietary rules capture these elements, ensuring the AI possesses a strong foundation of technical understanding.

Component-Level Knowledge - Rules exist to recognize specific parts of marine engines (e.g., impellers, thermostats, cooling systems, fuel injectors) and marine equipment and their interactions in a marine environment.

Example Rule: Rules exist as a guide to help the AI system understand how to respond to specific situations in a structured and consistent manner in a marine environment. These rules outline how the AI should interpret inputs, manage context, and deliver outputs that align with specific goals or desired behaviors. In the context of training, example rules provide clear frameworks that can influence or shape how an AI model behaves, especially in scenarios where domain-specific expertise or consistency is crucial.

System Interdependencies – Marine equipment and engines often experience problems that span multiple systems (e.g., electrical, mechanical, hydraulic). Proprietary rules exist to ensure the AI analyzes all related systems, much like a human marine mechanic would when diagnosing an issue.

Root Cause Analysis—The diagnostic module 142contains proprietary and novel rules that guide the AI to look beyond surface-level symptoms and focus on underlying causes. These rules ensure the AI can recognize when symptoms might point to deeper, systemic problems (e.g., persistent fuel issues might signal a clogged injector or fuel pump failure).

Step-by-Step Diagnostic Flow: The diagnostic module 142 includes novel and proprietary rules instructing the AI to follow predefined diagnostic checklist procedures. Additionally proprietary rules also instruct the AI to respond with structured, step-by-step instructions. For instance, if an engine won't start, the AI will suggest a step-by-step sequence for resolution. For example, checking fuel supply, spark plugs, battery voltage, and so on. This emulates the layered diagnostic approach used by human mechanics.

Mannerism Rules—Marine mechanics often adopt a clear, patient, and instructional communication style with boat owners or technicians. The diagnostic module 142 includes proprietary and novel rules to ensure the AI responds this way, avoiding jargon when necessary, providing clear troubleshooting advice, and explaining complex concepts in layman’s terms while maintaining the professional tone of a seasoned mechanic.

Industry Updates – Proprietary and novel rules exist that incorporate the latest manufacturer recommendations, service bulletins, and best practices, ensuring the AI remains up-to-date with the newest technologies in the marine industry.

Dynamic User Input Response – Proprietary and innovative rules are designed to dynamically adapt the AI's troubleshooting process in real-time, tailoring its approach to the specific needs and input of the user. Just as marine mechanics adjust their diagnostic methods based on context and feedback, these rules enable the AI to modify its responses as new information is provided during the conversation. For instance, if a user indicates that the spark plugs have already been replaced, the AI intelligently bypasses that step and proceeds to the next relevant test, streamlining the diagnostic flow to ensure efficiency and accuracy.

Handling Uncertainty and Referrals – Even experienced marine mechanics occasionally encounter issues requiring further diagnostics or specialized tools. Proprietary and novel rules guide the AI in handling uncertainty by setting confidence thresholds. If the AI’s confidence in a diagnosis falls below a certain level, proprietary and novel rules instruct the AI to communicate its confidence level to the user explicitly. This includes stating that the system has lower certainty in its current assessment and that further investigation may be required. Proprietary and novel rules ensure the AI presents this information clearly, explaining why additional diagnostics may be necessary and suggesting consulting a certified marine mechanic. The AI, guided by these rules, provides the rationale for the recommendation, ensuring the user understands the potential complexity and the need for professional assistance.

Additional Assistance Contact Information – Proprietary and novel rules instruct the AI to guide the user in locating relevant technical support, such as directing them to the appropriate manufacturer’s website or nearest authorized service center. Additionally, the AI is prompted to provide key contact details, including email addresses, phone numbers, and available support hours, ensuring the user has comprehensive information to reach the correct assistance.

In embodiments, the AI marine diagnostic system 102 can also provide training materials or sessions to enhance user interaction with the system. The AI marine diagnostic system 102 can also connect to IoT devices, which provide real-time data, enhancing diagnostic accuracy. The AI marine diagnostic system 102 can provide multiple language support would make the system usable by a broader range of users.

FIG. 2 illustrates a method for diagnosing marine equipment problems using the AI marine diagnostic system 102, according to aspects of the present disclosure. In embodiments, one or more of the stages can be performed by the diagnostic module 142. While FIG. 2 illustrates examples of stages of the method for diagnosing marine equipment problems, additional stages can be added and existing stages can be reordered, removed, and/or modified.

As illustrated in FIG. 2, in stage 1, a human user provides an input detailing a problem or posing a question (“Issue”) related to a specific piece of marine equipment or mechanical device (“Device”). The user input can include voice input describing the marine equipment and problems, text input describing the marine equipment and problems, images and videos captured of the marine equipment and problems, etc.

In stage 2A, the AI marine diagnostic system 102 accesses and retrieves relevant information from proprietary databases. The proprietary database, e.g., the marine data database 114 and the rules database 116, contains comprehensive data, including but not limited to, the manufacturer specifications, operational parameters, maintenance history, and other critical details (“Proprietary Data”) pertaining to the Device . The Proprietary Data is then combined with the human-provided input from stage 1 to contextualize the Issue accurately.

In stage 3A, the AI marine diagnostic system 102 integrates the combined data from stage 2 with a set of proprietary diagnostic and operational rules. The proprietary rules, e.g., stored within the rules database 116, are formulated to emulate a marine mechanic's diagnostic reasoning and problem-solving approach (“Proprietary Rules”). The Proprietary Rules guide the AI in interpreting the human input and formulating a response that mirrors expert human judgment.

In stage 4, the combined input, enriched by the Proprietary Data and governed by the Proprietary Rules, is submitted to the one or more machine learning models. The one or more machine learning models, for example, the models of the diagnostic module 142, process the input, applying advanced algorithms and machine learning techniques to generate a diagnostic response or a solution relevant to the Issue raised in stage 1.

In stage 5, the AI response is presented to the human user. This response may include diagnostic information, suggested maintenance actions, or solutions that address the Issue, along with, if necessary, recommendations for further human assistance or expert intervention.

Returning to FIG. 1, the processing device 104, the communication device 106, the memory device 108, and the I/O interface 110 can be interconnected via a system bus. The system bus can be and/or include a control bus, a data bus, an address bus, and the like. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the AI marine diagnostic system 102 can include multiple processing devices 104, whether the same type or different types.

The memory device 108 can be and/or include one or more computerized storage media capable of storing electronic data temporarily, semi-permanently, or permanently. The memory device 108 can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 108. While FIG. 1 illustrates a single memory device 108, the AI marine diagnostic system 102 can include multiple memory devices 108, whether the same type or different types.

The communication device 106 enables the AI marine diagnostic system 102 to communicate with other devices and systems. The communication device 104 can include hardware and/or software for generating and communicating signals over a direct and/or indirect network communication link. As used herein, a direct link can include a link between two devices where information is communicated from one device to the other without passing through an intermediary. For example, the direct link can include a BluetoothTM connection, a Zigbee connection, a Wifi DirectTM connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The AI marine diagnostic system 102 can communicate with one or more network resources via the network 116. The one or more network resources can include external databases, social media platforms, search engines, file servers, web servers, or any type of computerized resource that can communicate with the AI marine diagnostic system 102 via the network 116.

In embodiments, the components and functionality of the AI marine diagnostic system 102 can be hosted and/or instantiated on a “cloud” and/or “cloud service.” As used herein, a "cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the AI marine diagnostic system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the network environment 100, including the AI marine diagnostic system 102 and the user device 120 can include a user interface for outputting information in a format perceptible by a user and receiving input from the user. For example, the AI marine diagnostic system 102 can communicate with the user interface via the I/O interface 112. In another example, the user device 120 can include the user interface for providing information to and receiving information from the user 118. The user interface can display graphical user interfaces (“GUIs”) generated by the AI marine diagnostic system 102 and/or the application 122. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method for artificial intelligence-assisted diagnostics, comprising:
receiving input describing marine equipment and at least one issue associated with the marine equipment;
determining an identification of the marine equipment;
applying the input and the identification of the marine equipment to one or more machine learning algorithms, wherein:
the one or more machine learning algorithms implement one or more rules that classify and identify problems in the marine equipment, and
the one or more machine learning algorithms are trained based on metadata for the marine equipment and components of the marine equipment; and
outputting at least one solution to the at least one issue.

2. The method of claim 1, further comprising:
outputting at least one recommendation for a mechanic to assist in addressing the at least one issue.

3. The method of claim 1, wherein the one or more machine learning algorithms are trained based on historical repair process for the marine equipment.

4. The method of claim 1, wherein the input comprises one or more of voice input describing the at least one issue, text input describing the at least one issue, and images of the marine equipment.

5. The method of claim 1, wherein the at least one solution comprises detailed instruction for resolving the at least one issue.

6. The method of claim 1, wherein the identification of the marine equipment comprises a maintenance history of the marine equipment.

7. The method of claim 1, further comprising:
retraining the one or more machine learning based on feedback on the at least one solution.

8. A computer-readable medium storing instructions for causing a processing device to perform a method for artificial intelligence-assisted diagnostics, the method comprising:
receiving input describing marine equipment and at least one issue associated with the marine equipment;
determining an identification of the marine equipment;
applying the input and the identification of the marine equipment to one or more machine learning algorithms, wherein:
the one or more machine learning algorithms implement one or more rules that classify and identify problems in the marine equipment, and
the one or more machine learning algorithms are trained based on metadata for the marine equipment and components of the marine equipment; and
outputting at least one solution to the at least one issue.

9. The computer-readable medium of claim 8, the method further comprising:
outputting at least one recommendation for a mechanic to assist in addressing the at least one issue.

10. The method of claim 8, wherein the one or more machine learning algorithms are trained based on historical repair process for the marine equipment.

11. The computer-readable medium of claim 8, wherein the input comprises one or more of voice input describing the at least one issue, text input describing the at least one issue, and images of the marine equipment.

12. The computer-readable medium of claim 8, wherein the at least one solution comprises detailed instruction for resolving the at least one issue.

13. The computer-readable medium of claim 8, wherein the identification of the marine equipment comprises a maintenance history of the marine equipment.

14. The computer-readable medium of claim 8, the method further comprising:
retraining the one or more machine learning based on feedback on the at least one solution.

15. A system for performing a method for artificial intelligence-assisted diagnostics, the system comprising:
a memory device storing instructions;
a processing device coupled to the memory device and configured to execute the instructions to perform a method comprising:
receiving input describing marine equipment and at least one issue associated with the marine equipment;
determining an identification of the marine equipment;
applying the input and the identification of the marine equipment to one or more machine learning algorithms, wherein:
the one or more machine learning algorithms implement one or more rules that classify and identify problems in the marine equipment, and
the one or more machine learning algorithms are trained based on metadata for the marine equipment and components of the marine equipment; and
outputting at least one solution to the at least one issue.
